(19) United States
(12) Patent Application Publication
(10) Pub. No.: US 2018/0203266 A1
(43) Pub. Date: Jul. 19, 2018

(54) LIQUID CRYSTRAL MEDIUM MIXTURE AND LIQUID CRYSTAL DISPLAY PANEL

(71) Applicant: Shenzhen China Star Optoelectronics Technology Co., Ltd., Shenzhen, Guangdong (CN)

(72) Inventors: Xingwu CHEN, Shenzhen, Guangdong (CN); Xiaolong MA, Shenzhen, Guangdong (CN)

(73) Assignee: Shenzhen China Star Optoelectronics Technology Co., Ltd., Shenzhen, Guangdong (CN)

(21) Appl. No.: 15/305,326

(22) PCT Filed: Sep. 14, 2016
(86) PCT No.: PCT/CN2016/098935

§ 371 Date: Oct. 19, 2016

(30) Foreign Application Priority Data
Aug. 10, 2016 (CN) 201610659013.9

(51) Int. Cl. G02F 1/137; G02F 1/1337; G02F 1/1343; C09K 19/54; C09K 19/38

(52) U.S. Cl. CPC G02F 1/137; G02F 1/133711; G02F 1/134309; C09K 2019/546; C09K 19/3852; G02F 2001/13712; C09K 19/542

(57) ABSTRACT

The invention provides a liquid crystal medium mixture including a liquid crystal material, an antioxidant and at least one kind of polymerizable monomer capable of undergoing polymerization reaction under ultraviolet light irradiation. Under an ultraviolet light irradiation, the antioxidant would make the polymerizable monomer be slowly polymerized to form a homogeneous polymer network in the liquid crystal material and thereby make the liquid crystal material have a fast-response speed when a voltage is applied thereto. The invention further provides a liquid crystal display panel.

### TECHNICAL FIELD

The invention relates to the field of display technology, and more particularly to a liquid crystal medium mixture and a liquid crystal display panel.

### DESCRIPTION OF RELATED ART

A VA-type (vertical alignment display technology) liquid crystal display mode generally employs a negative liquid crystal material. When no voltage is applied thereto, a long axis of liquid crystal molecules is perpendicular to a surface of a substrate; and when a voltage is applied in a direction of the long axis of liquid crystal molecules, the liquid crystal material trends to arrange in a direction perpendicular to an electric field, i.e., liquid crystal molecules are tilted towards a direction parallel to the substrate.

Nowadays, there are many methods to accelerate a rotation velocity of liquid crystal molecules when a voltage is applied onto the liquid crystal molecules of VA-type liquid crystal display mode. A first method is to prepare protrusions on a substrate, so as to make liquid crystal molecules form certain pretilt angles near the protrusions and thereby guide the liquid crystal molecules to tilt towards a predetermined direction. A second method is to form slit (groove) electrodes by etching on indium tin oxide electrode layers of upper and lower substrates, so as to make an electric field generate a certain tilt angle and thereby control tilt directions of liquid crystal molecules, which is called as a patterned vertical alignment (PVA) technology. A third method is that forming gaps by etching on an indium tin oxide electrode layer at the side of TFT substrate, the other side being an overall indium tin oxide electrode layer, and meanwhile a polymerizable monomer (generally also referred to as reactive monomer, shorted as RM) being added into a liquid crystal material. By applying a voltage and using a polymerization under ultraviolet light irradiation, the polymerization process generates a phase separation, so that protrusions are formed on a surface of substrate and thereby guide the liquid crystal molecules to tilt towards a predetermined direction and achieve an alignment effect, which is called as a polymer stabilized vertical alignment (PSVA) technology. However, a response speed of the liquid crystal material in the above methods is difficult to meet the needs of the development of display panel, and therefore it is necessary to provide a liquid crystal medium mixture which can increase a response speed of the liquid crystal material.

### SUMMARY

Accordingly, a technical problem primarily to be solved by the invention is to provide a liquid crystal medium mixture which can increase a response speed of a liquid crystal material.

In order to solve the technical problem, a technical solution provided in the invention is to provide a liquid crystal medium mixture including a liquid crystal material, an antioxidant and at least one kind of polymerizable monomer capable of undergoing polymerization reaction under ultraviolet light irradiation. Under an ultraviolet light irradiation, the antioxidant would make the polymerizable monomer be slowly polymerized to form a homogeneous polymer network in the liquid crystal material, and thereby make the liquid crystal material have a fast-response speed when a voltage is applied thereto. A ratio of a mass of the antioxidant occupied in a total mass of the liquid crystal medium mixture is greater than 0 and less than or equal to 1%. A mass of the polymerizable monomer is 0.3%-30% of the total mass of the liquid crystal medium mixture. A structural formula of the antioxidant is

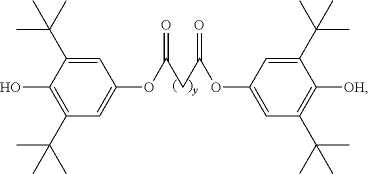

where y is in the range of 1-11.

In an embodiment, the polymerizable monomer includes at least one of acrylate, acrylate derivative, methacrylate, methacrylate derivative, styrene, styrene derivative, epoxy resin and aliphatic amine epoxy resin.

In an embodiment, a structural formula of the polymerizable monomer is

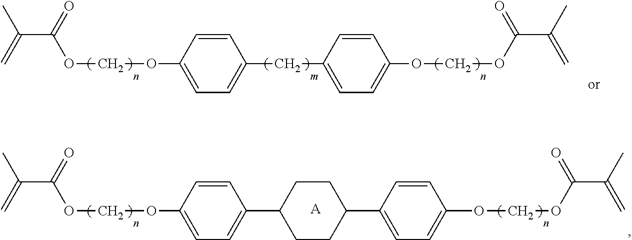

where m is in the range of 1-6, n is in the range of 1-7, and A is one of benzene, benzyl, fluorobenzene, para-ethyl benzene, para-propyl benzene and para-methanoic phenyl ester.

In an embodiment, the liquid crystal material includes a diluent, a first monomer and a second monomer. The first monomer is configured for increasing a birefringence of the liquid crystal material, the second monomer is configured for increasing a negative dielectric anisotropy of the liquid crystal material.

In order to solve the technical problem, another technical solution provided in the invention is to provide a liquid crystal medium mixture including a liquid crystal material, an antioxidant and at least one kind of polymerizable monomer capable of undergoing polymerization reaction under ultraviolet light irradiation. Under an ultraviolet light irradiation, the antioxidant would make the polymerizable monomer be slowly polymerized to form a homogeneous polymer network in the liquid crystal material, and thereby make the liquid crystal material have a fast-response speed when a voltage is applied thereto.

In an embodiment, a structural formula of the antioxidant is

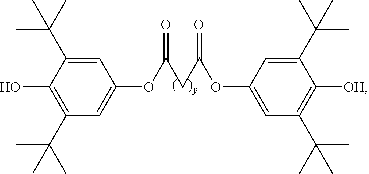

where y is in the range of 1-11.

In an embodiment, a ratio of a mass of the antioxidant occupied in a total mass of the liquid crystal medium mixture is greater than 0 and less than or equal to 1%. A mass of the polymerizable monomer is 0.3%-30% of the total mass of the liquid crystal medium mixture.

In an embodiment, the polymerizable monomer includes at least one of acrylate, acrylate derivative, methacrylate, methacrylate derivative, styrene, styrene derivative, epoxy resin and aliphatic amine epoxy resin.

In an embodiment, a structural formula of the polymerizable monomer is

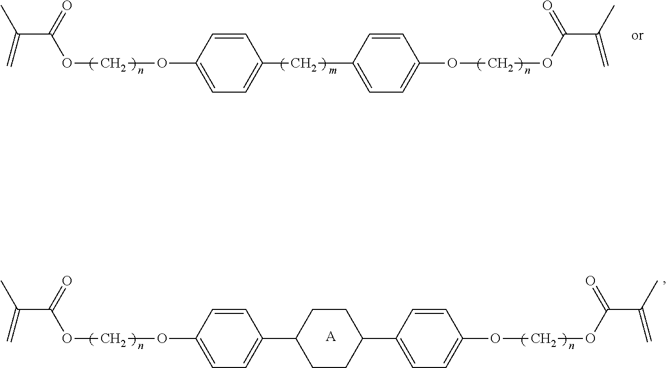

where m is in a range of 1-6, n is in a range of 1-7, and A is one of benzene, benzyl, fluorobenzene, para-ethyl benzene, para-propyl benzene and para-methanoic phenyl ester.

In an embodiment, the liquid crystal material includes a diluent, a first monomer and a second monomer. The first monomer is configured for increasing a birefringence of the liquid crystal material, the second monomer is configured for increasing a negative dielectric anisotropy of the liquid crystal material.

In order to solve the technical problem, still another technical solution provided in the invention is to provide a liquid crystal display panel. The liquid crystal display panel includes: oppositely disposed a first substrate and a second substrate, and a liquid crystal medium mixture disposed between the first substrate and the second substrate. The liquid crystal medium mixture includes a liquid crystal material, an antioxidant and at least one kind of polymerizable monomer capable of undergoing polymerization reaction under ultraviolet light irradiation. Under an ultraviolet light irradiation, the antioxidant would make the polymerizable monomer be slowly polymerized to form a homogeneous polymer network in the liquid crystal material and thereby make the liquid crystal material have a fast-response speed when a voltage is applied thereto.

In an embodiment, a structural formula of the antioxidant is

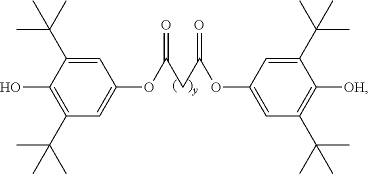

where y is in the range of 1-11.

In an embodiment, a ratio of a mass of the antioxidant occupied in a total mass of the liquid crystal medium mixture is greater than 0 and less than or equal to 1%, and a mass of the polymerizable monomer is 0.3%-30% of the total mass of the liquid crystal medium mixture.

In an embodiment, the polymerizable monomer includes at least one of acrylate, acrylate derivative, methacrylate, methacrylate derivative, styrene, styrene derivative, epoxy resin and aliphatic amine epoxy resin.

In an embodiment, a structural formula of the polymerizable monomer is

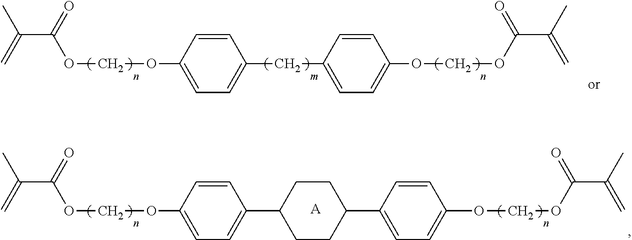

where m is in the range of 1-6, n is in the range of 1-7, and A is one of benzene, benzyl, fluorobenzene, para-ethyl benzene, para-propyl benzene and para-methanoic phenyl ester.

In an embodiment, the liquid crystal material includes a diluent, a first monomer and a second monomer. The first monomer is configured for increasing a birefringence of the liquid crystal material, the second monomer is configured for increasing a negative dielectric anisotropy of the liquid crystal material.

Efficacy of the invention is that: different from the prior art, in the liquid crystal medium mixture provided in the invention, by adding the antioxidant and the polymerizable monomer into the liquid crystal medium mixture, so that the liquid crystal medium mixture under the ultraviolet light irradiation, the polymerizable monomer slowly polymerizes to form a homogeneous polymer network in the liquid crystal material and thereby makes the liquid crystal material have fast-response speed and dark-state effect when a voltage is applied thereto.

### BRIEF DESCRIPTION OF THE DRAWINGS

FIG. 1 is a schematic cross-sectional view of a liquid crystal display panel according to the invention.

FIG. 2 shows a manufacturing process of substrates in a manufacturing process of a liquid crystal display panel according to the invention.

FIG. 3 is a schematic cross-sectional view showing a liquid crystal medium mixture being added between the substrates in the manufacturing process of the liquid crystal display panel according to the invention.

FIG. 4 is a schematic cross-sectional view of the liquid crystal display panel shown in FIG. 3 being irradiated by an ultraviolet light.

FIG. 5 is an image showing a polymer network structure of a liquid crystal display panel according to the invention.

### DETAILED DESCRIPTION OF EMBODIMENTS

In the following, the invention will be described in detail with reference to embodiments and accompanying drawings.

The invention provides a liquid crystal medium mixture adapted for a liquid crystal display panel and including a liquid crystal material, an antioxidant and at least one kind of polymerizable monomer capable of undergoing polymerization reaction under ultraviolet light irradiation. Under an ultraviolet light irradiation, the antioxidant makes the polymerizable monomer be slowly polymerized to form a homogeneous polymer network in the liquid crystal material and thereby make the liquid crystal material have a fast-response speed when a voltage is applied thereto.

It should be understood that the liquid crystal material, the antioxidant and the polymerizable monomer are uniformly mixed.

The liquid crystal material is a nematic phase liquid crystal material. The liquid crystal material includes a diluent, a first monomer and a second monomer. The diluent is configured (i.e., structured and arranged) for increasing viscosity, solubility and other properties of other substances in the liquid crystal material or the liquid crystal medium mixture. The first monomer is configured for increasing a birefringence of the liquid crystal material, and the second monomer is configured for increasing a negative dielectric anisotropy of the liquid crystal material.

A structural formula of the diluent is

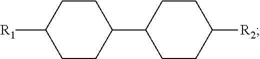

the first monomer is at least one of

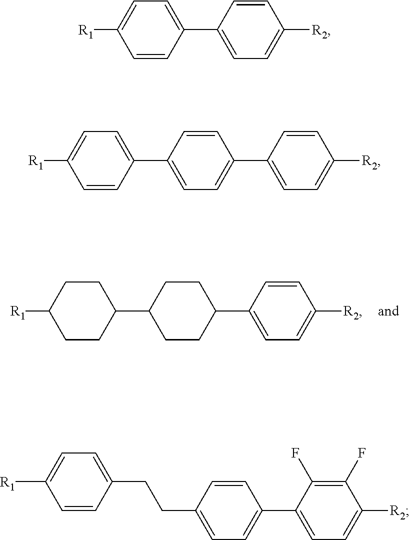

the second monomer is at least one of

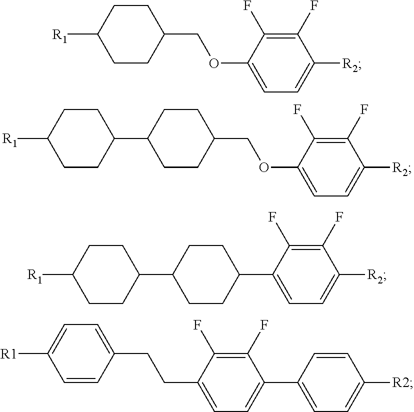

where R1 and R2 each are an alkyl chain, e.g., CₓH₂ₓ₊₁, OCₓ₁H₂ₓ₊₁, CₓH₂ₓ, OCₓH₂ₓ and the like, x is in the range of 1-7.

In a specific embodiment, the diluent is at least one of

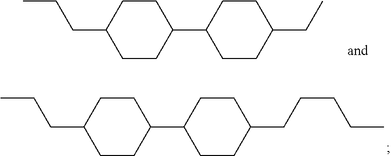

the first monomer is at least one of

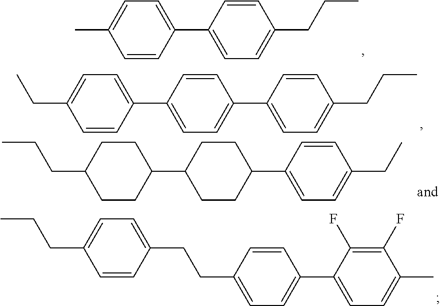

the second monomer is at least one of

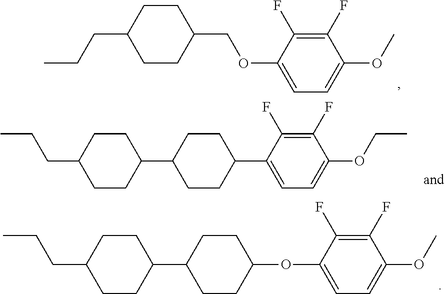

A structural formula of the antioxidant is

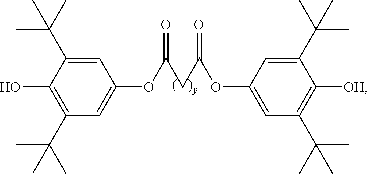

where y is in the range of 1-11.

In a specific embodiment, the structural formula of the antioxidant is

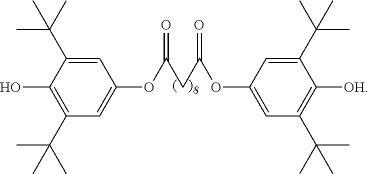

A ratio of a mass of the antioxidant occupied in a total mass of the liquid crystal medium mixture is greater than 0 and less than or equal to 1%, e.g., is 0.1%, 0.5%, 0.8%, 1% and the like.

The polymerizable monomer includes at least one of acrylate, acrylate derivative, methacrylate, methacrylate derivative, styrene, styrene derivative, epoxy resin and aliphatic amine epoxy resin.

It should be understood that the polymerizable monomer may further include one of benzene, benzyl, fluorobenzene, para-ethyl benzene, para-propyl benzene and para-methanoic phenyl ester.

For example, a structural formula of the polymerizable monomer is

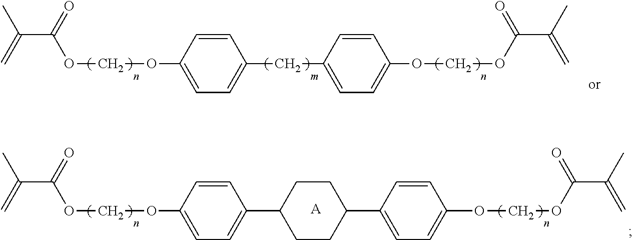

where m is in the range of 1-6, n is in the range of 1-7, and A is one of benzene, benzyl, fluorobenzene, para-ethyl benzene, para-propyl benzene and para-methanoic phenyl ester.

In a specific embodiment, the structural formula of the polymerizable monomer is

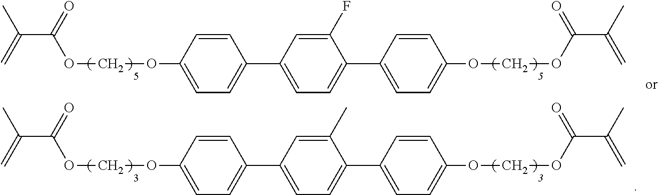

It should be understood that the structure of polymerizable monomer is long and thus is easy to form a polymer network under ultraviolet light irradiation.

It should be understood that a ratio of a mass of the polymerizable monomer occupied in a total mass of the liquid crystal medium mixture is 0.3%-30%, e.g., is 0.3%, 10%, 20%, 30% and the like.

In a specific embodiment, compositions of the liquid crystal medium mixture include:
compositions of the liquid crystal material being that

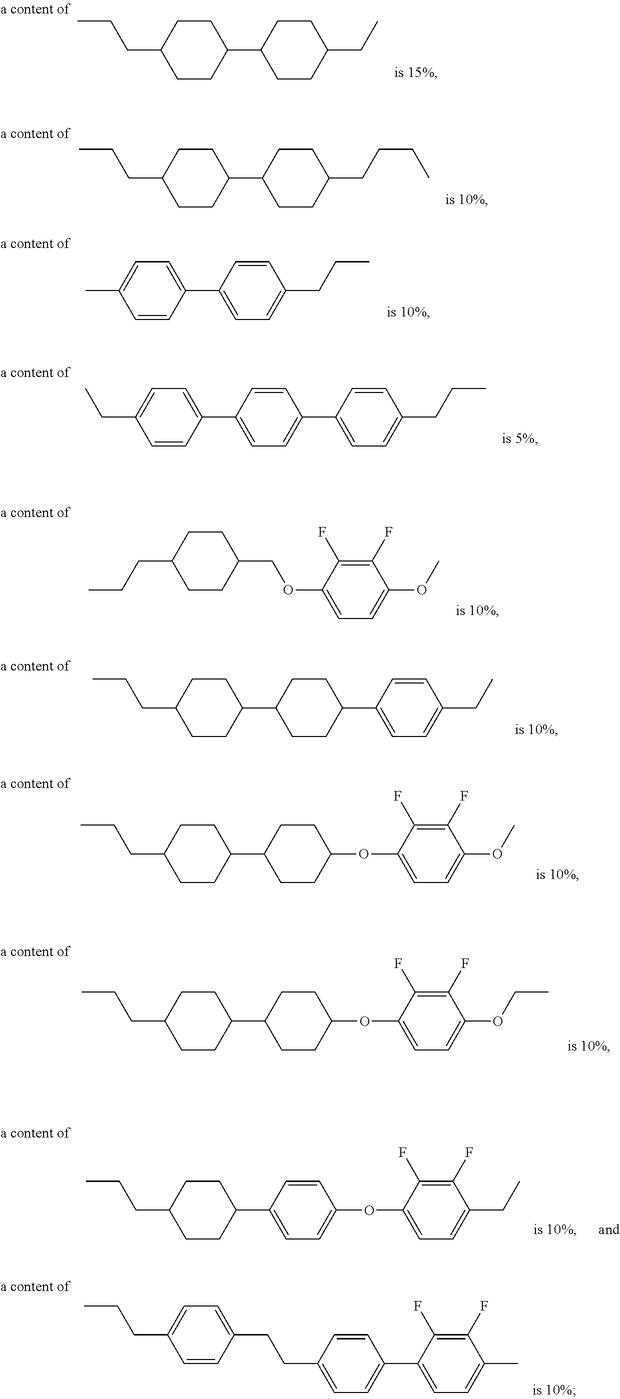

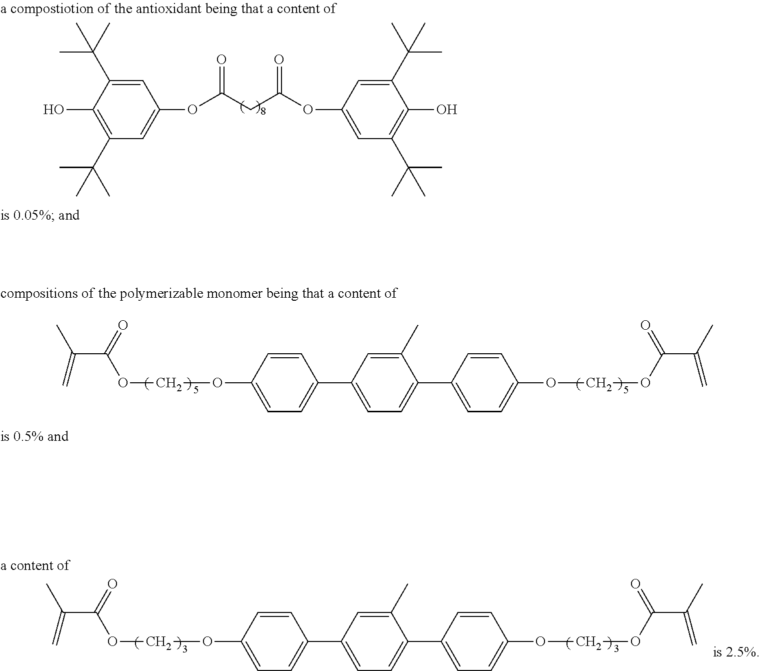

In the liquid crystal medium mixture provided in the invention, by adding the antioxidant and the polymerizable monomer into the liquid crystal medium mixture, so that the liquid crystal medium mixture under ultraviolet light irradiation, the polymerizable monomer is slowly polymerized to form a homogeneous polymer network in the liquid crystal material and thereby make the liquid crystal material have fast-response speed and dark-state effect when a voltage is applied thereto. In addition, the liquid crystal material includes a polyphenyls monomer, which can effectively increase the birefringence of the liquid crystal material and thereby achieve an effect of low thick liquid crystal box.

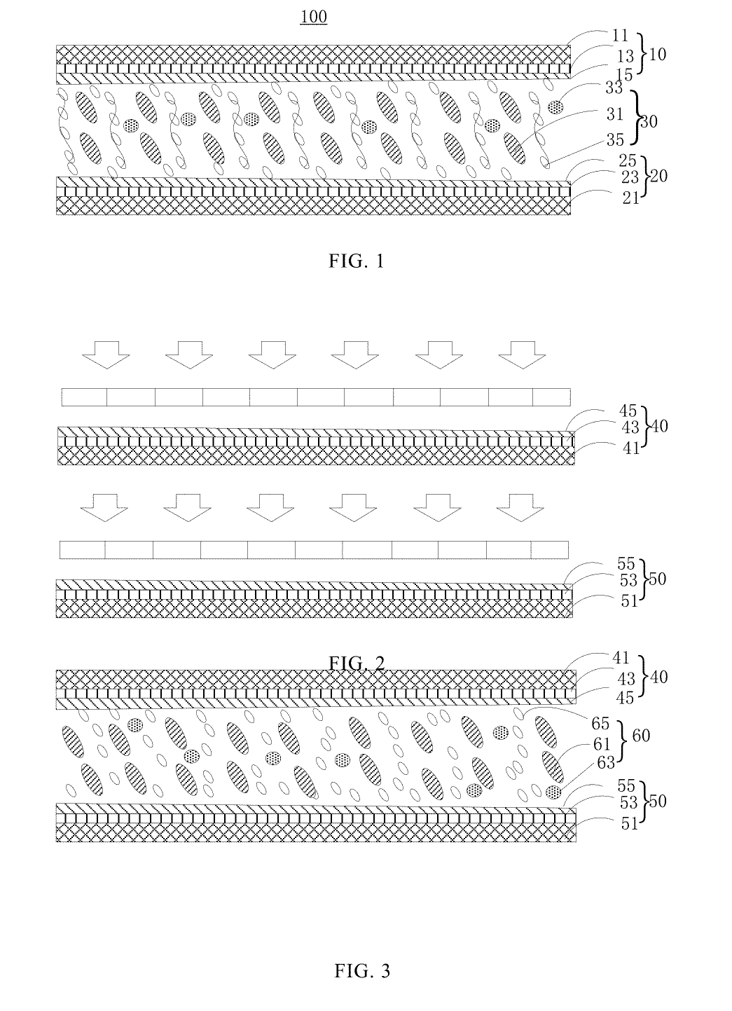

Please refer to FIG. 1, the invention also provides a liquid crystal display panel 100. The liquid crystal display panel 100 may be but not limited to a field sequential liquid crystal display device, which includes oppositely disposed a first substrate 10 and a second substrate 20, and a liquid crystal medium mixture 30 disposed between the first substrate 10 and the second substrate 20.

It should be understood that the first substrate 10 is a thin film transistor array substrate, and the second substrate 20 is a color film substrate.

The first substrate 10 includes a first base 11, a first electrode 13 and a first alignment layer 15 sequentially formed in that order. The alignment layer 15 is a vertical alignment layer.

The second substrate 20 includes a second base 21, a second electrode 23 and a second alignment layer 25 sequentially formed in that order. The second alignment layer 25 is a vertical alignment layer.

Furthermore, both of the first alignment layer 15 and the second alignment layer 25 are photoalignment layers. When a polarized ultraviolet light irradiation is applied to the photoalignment layers, a certain pretilt angle would be formed, which makes a consistency of a rotational direction of the liquid crystal material be better.

It should be understood that, when disposing the first substrate 10 and the second substrate 20, the first alignment layer 15 and the second alignment layer 25 are disposed close to each other, and the first base 11 and the second base 21 are disposed away from each other.

The liquid crystal medium mixture 30 includes a liquid crystal material 31, an antioxidant 33 and at least one kind of polymerizable monomer 35 capable of undergoing polymerization reaction under the ultraviolet light irradiation. When the ultraviolet light irradiation is applied, the antioxidant 33 would make the polymerizable monomer 35 be slowly polymerized to form a homogeneous polymer network in the liquid crystal material 31 and thereby make the liquid crystal material 31 have a fast-response speed when a voltage is applied thereto. It should be understood that the liquid crystal material 31, the antioxidant 33 and the polymerizable monomer 35 are uniformly mixed.

The liquid crystal material 31 is a nematic phase liquid crystal material. The liquid crystal material 31 includes a diluent, a first monomer and a second monomer. The diluent is configured for increasing viscosity, solubility and other property of other substances in the liquid crystal material or the liquid crystal medium mixture. The first monomer is configured for increasing a birefringence of the liquid crystal material, and the second monomer is configured for increasing a negative dielectric anisotropy of the liquid crystal material.

A structural formula of the diluent is

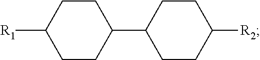

the first monomer is at least one of:

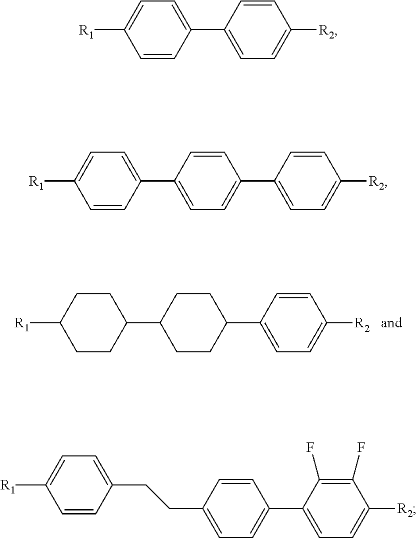

the second monomer is at least one of:

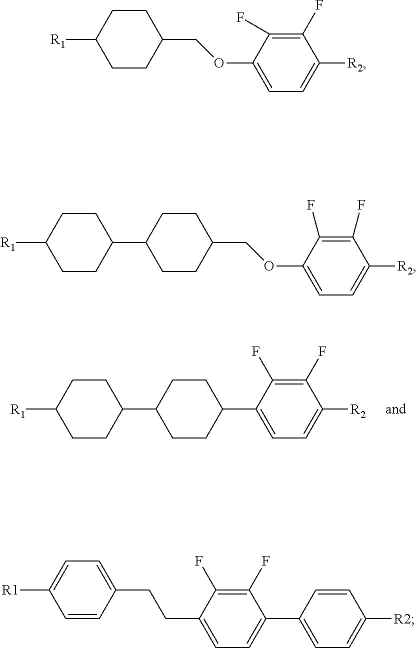

where R1 and R2 each are an alkyl chain, e.g., CₓH₂ₓ₊₁, OCₓH₂ₓ₊₁, CₓH₂ₓ, OCₓH₂ₓ and the like, x is in the range of 1-7.

A structural formula of the antioxidant 33 is

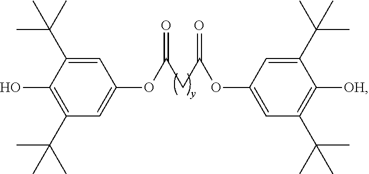

where y is in the range of 1-11.

A ratio of a mass of the antioxidant 33 occupied in a total mass of the liquid crystal medium mixture 30 is greater than 0 and less than or equal to 1%, e.g., is 0.1%, 0.5%, 0.8%, 1% and the like.

The polymerizable monomer 35 includes at least one of acrylate, acrylate derivative, methacrylate, methacrylate derivative, styrene, styrene derivative, epoxy resin and aliphatic amine epoxy resin.

It should be understood that the polymerizable monomer 35 may further include one of benzene, benzyl, fluorobenzene, para-ethyl benzene, para-propyl benzene and para-methanoic phenyl ester.

For example, a structural formula of the polymerizable monomer 35 is

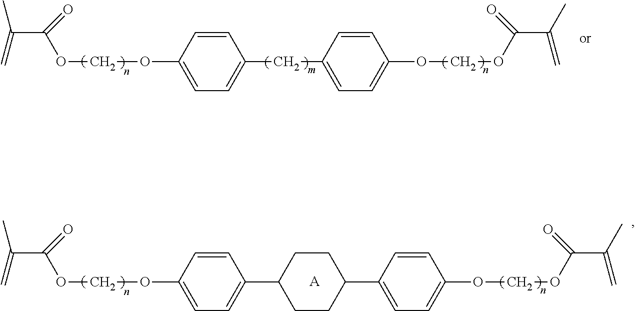

where m is in the range of 1-6, n is in the range of 1-7, and A is one of benzene, benzyl, fluorobenzene, para-ethyl benzene, para-propyl benzene and para-methanoic phenyl ester.

It should be understood that the structure of the polymerizable monomer 35 is long and thus is easy to form the polymer network under ultraviolet light irradiation.

It should be understood that a ratio of a mass of the polymerizable monomer 35 occupied in a total mass of the liquid crystal medium mixture 30 is 0.3%-30%, e.g., is 0.3%, 10%, 20%, 30% and the like.

In the liquid crystal display panel 100 provided in the invention, by adding the antioxidant 33 and the polymerizable monomer 55 into the liquid crystal medium mixture 30, when the ultraviolet light irradiation is applied to the liquid crystal medium mixture 30, the polymerizable monomer is slowly polymerized to form the a homogeneous polymer network in the liquid crystal material 31 and thereby make the liquid crystal material 31 have fast-response speed and dark-state effect when a voltage is applied thereto. In addition, the liquid crystal material 31 includes a polyphenyls monomer, which can effectively increase a birefringence of the liquid crystal material 31 and thereby achieve an effect of low thick liquid crystal box.

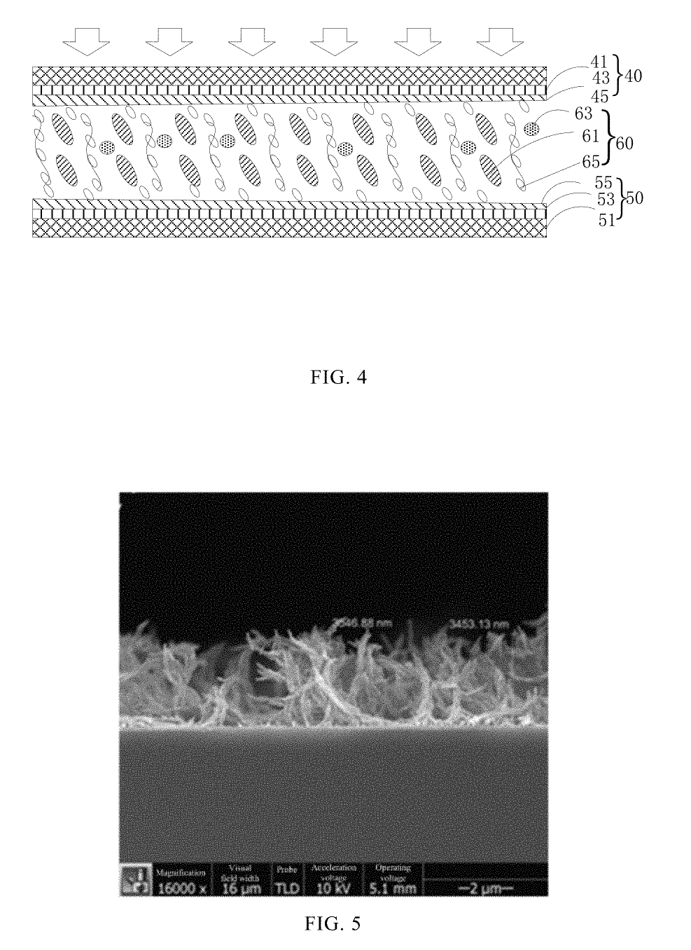

Please refer to FIG. 2 to FIG. 4 together, a manufacturing method of a liquid crystal display panel is further provided in the invention, which includes following steps.

Step S101, please refer to FIG. 2, a first substrate 40 and a second substrate 50 are provided.

More specifically, a first base 41 and a second base 51 are provided. A first electrode 43 and a first alignment layer 45 are sequentially formed on the first base 41 in that order. A second electrode 53 and a second alignment layer 55 are sequentially formed on the second base 51 in that order.

The first substrate 40 is a thin film transistor array substrate, and the second substrate 50 is a color film substrate.

The first alignment layer 45 and the second alignment layer 55 both are vertical alignment layers. Furthermore, the first alignment layer 45 and the second alignment layer 55 are photoalignment layers.

It should be understood that, when a polarized ultraviolet light irradiation is applied to the photoalignment layers, the photoalignment layers each form a certain pretilt angle and thereby make a consistency of rotational direction of the liquid crystal material of the manufactured liquid crystal display panel be better.

Step S102, a liquid crystal material 61 is prepared. In particular, a diluent, a first monomer and a second monomer are mixed according a certain proportion, then are heated to 80° C. and stirred well, and afterwards are filtered to obtain the liquid crystal material 61.

It should be understood that impurities in raw materials can be filtered out by filtering.

It should be understood that the liquid crystal material 61 is a nematic phase liquid crystal material. The diluent is configured for increasing viscosity, solubility and other property of other substances in the liquid crystal material 61 or the liquid crystal medium mixture. The first monomer is configured for increasing a birefringence of the liquid crystal material, and the second monomer is configured for increasing a negative dielectric anisotropy of the liquid crystal material.

A structural formula of the diluent is

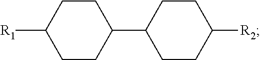

the first monomer is at least one of

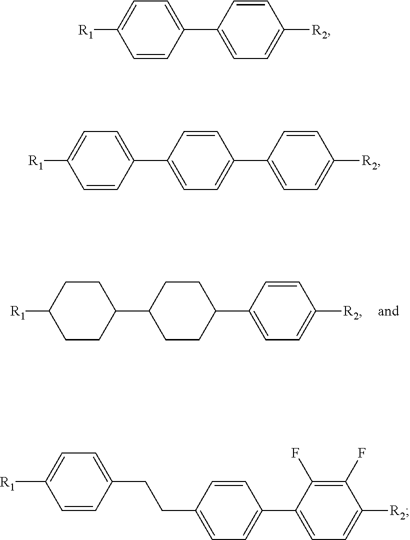

the second monomer is at least one of

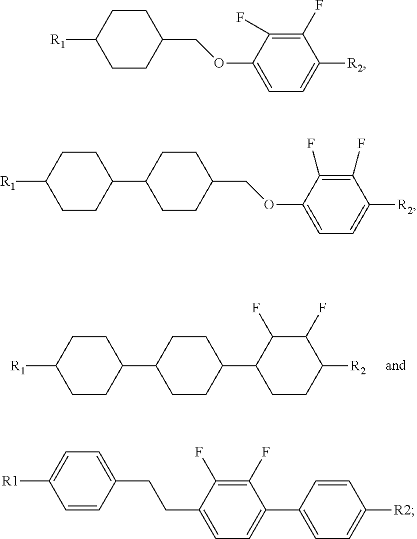

where R1 and R2 each are an alkyl chain, e.g., CₓH₂ₓ₊₁, OCₓ₁H₂ₓ₊₁, CₓH₂ₓ, OCₓH₂ₓ and the like, x is in the range of 1-7.

Step S103, a liquid crystal medium mixture 60 is prepared. In the above prepared liquid crystal material 61, an antioxidant 63 and at least one kind of polymerizable monomer 65 capable of undergoing polymerization reaction under ultraviolet light irradiation are added thereto and mixed according a certain proportion, then are heated to 80° C. and stirred well and afterwards are filtered to obtain the liquid crystal medium mixture 60.

It should be understood that impurities in raw materials can be filtered out by filtering.

A structural formula of the antioxidant 63 is

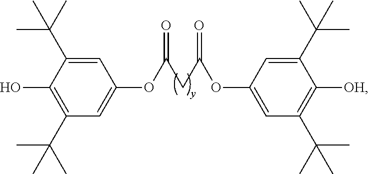

where y is in the range of 1-11.

A ratio of a mass of the antioxidant 63 occupied in a total mass of the liquid crystal medium mixture is greater than 0 and less than or equal to 1%, e.g., is 0.1%, 0.5%, 0.8%, 1% and the like.

The polymerizable monomer 65 includes at least one of acrylate, acrylate derivative, methacrylate, methacrylate derivative, styrene, styrene derivative, epoxy resin and aliphatic amine epoxy resin.

It should be understood that the polymerizable monomer 65 further includes one of benzene, benzyl, fluorobenzene, para-ethyl benzene, para-propyl benzene and para-methanoic phenyl ester.

For example, a structural formula of the polymerizable monomer 65 is

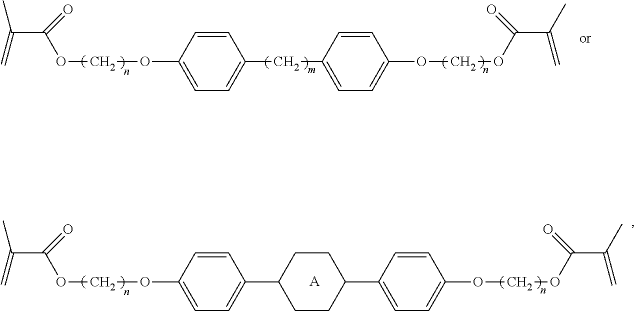

where m is in the range of 1-6, n is in the range of 1-7, and A is one of benzene, benzyl, fluorobenzene, para-ethyl benzene, para-propyl benzene and para-methanoic phenyl ester.

It should be understood that a ratio of a mass of the polymerizable monomer occupied in a total mass of the liquid crystal medium mixture is 0.3%-30% 30, e.g., is 0.3%, 10%, 20%, 30% and the like.

Step S104, please refer to FIG. 3, the above prepared liquid crystal medium mixture 60 is dripped onto one substrate of the first substrate 40 and the second substrate 50, and the other substrate is disposed covering on the liquid crystal medium mixture 60, so that the liquid crystal medium mixture 60 is fit between the first substrate 40 and the second substrate 50.

Step S105, please refer to FIG. 5, an ultraviolet light is used to irradiate one of the first substrate 40 and the second substrate 50, under the effect of the antioxidant 63, the polymerizable monomer 65 slowly polymerizes to form a homogeneous polymer network in the liquid crystal material 61 and thereby makes the liquid crystal material 61 have a fast-response speed when a voltage applied thereto.

It should be understood that the polymer network formed by the polymerization reaction and the liquid crystal material 61 undergo a phase separation, so that along a direction of a long axis of the liquid crystal material 61, the surfaces of the first substrate 40 and the second substrate 50 form a homogeneous polymer network.

A wavelength of the ultraviolet light for irradiation is 313 nm or 365 nm. When the wavelength is 313 nm, an intensity range is greater than 0 and less than or equal to 0.6 mW/cm², e.g., 0.1 mW/cm², 0.3 mW/cm² or 0.6 mW/cm². When the wavelength is 365 nm, an intensity range is 20-100 mW/cm², e.g., 20 mW/cm², 50 mW/cm², 80 mW/cm² or 100 mW/cm².

A reaction temperature is in the range of 30-60° C.

Different from the prior art, the invention adds the antioxidant 63 and the polymerizable monomer 65 into the liquid crystal medium mixture 60, when an ultraviolet light irradiation is applied to the liquid crystal medium mixture 60, the polymerizable monomer is slowly polymerized to form the a homogeneous polymer network in the liquid crystal material 61 and thereby make the liquid crystal material 61 have a fast-response speed and a dark-state effect when a voltage is applied thereto. In addition, the liquid crystal material 61 contains a polyphenyls monomer, which can effectively increase the birefringence of the liquid crystal material 61 and thereby achieve an effect of low thickness liquid crystal box.

### Example 1

A voltage of 2.3V is applied between alignment layers, during performing a curing by an ultraviolet light, a response time Ton is 1.09 ms and Toff is 0.78 ms; and after being cured by the ultraviolet light, an n-hexane is used to remove the liquid crystal material and then a SEM is used to scan, an image of a polymer network structure is obtained as shown in FIG. 5.

As seen from FIG. 5, a height of the polymer network is same as that of the liquid crystal box, and the polymer network is homogeneously/uniformly formed in the liquid crystal box.

It should be understood that the foregoing discussion only is some embodiments of the invention, and therefore it is not limited to the protection scope of the invention, any equivalent structures or equivalent transformation of processes made based on the specification and the accompanying drawings of the invention, or directly or indirectly being used in other related technical field, are similarly included within the protection scope of the invention.

What is claimed is:

1. A liquid crystal medium mixture comprising a liquid crystal material, an antioxidant and at least one kind of polymerizable monomer capable of undergoing polymerization reaction under ultraviolet light irradiation; wherein under an ultraviolet light irradiation, the antioxidant is configured for making the polymerizable monomer be slowly polymerized to form a homogeneous polymer network in the liquid crystal material and thereby make the liquid crystal material have a fast-response speed when a voltage is applied thereto; a ratio of a mass of the antioxidant occupied in a total mass of the liquid crystal medium mixture is greater than 0 and less than or equal to 1%, and a mass of the polymerizable monomer is 0.3%-30% of the total mass of the liquid crystal medium mixture; a structural formula of the antioxidant is 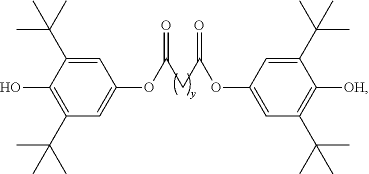
where y is in the range of 1-11.

2. The liquid crystal medium mixture according to claim 1, wherein the polymerizable monomer comprises at least one selected from a group consisting of acrylate, acrylate derivative, methacrylate, methacrylate derivative, styrene, styrene derivative, epoxy resin and aliphatic amine epoxy resin.

3. The liquid crystal medium mixture according to claim 2, wherein a structural formula of the polymerizable monomer is 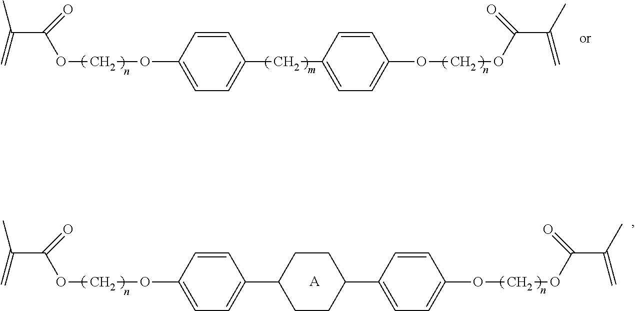
where m is in the range of 1-6, n is in the range of 1-7, and A is one selected from a group consisting of benzene, benzyl, fluorobenzene, para-ethyl benzene, para-propyl benzene and para-methanoic phenyl ester.

4. The liquid crystal medium mixture according to claim 1, wherein the liquid crystal material comprises a diluent, a first monomer and a second monomer; the first monomer is configured for increasing a birefringence of the liquid crystal material, and the second monomer is configured for increasing a negative dielectric anisotropy of the liquid crystal material.

5. A liquid crystal medium mixture comprising a liquid crystal material, an antioxidant and at least one kind of polymerizable monomer capable of undergoing polymerization reaction under ultraviolet light irradiation; wherein under an ultraviolet light irradiation, the antioxidant is configured for making the polymerizable monomer be slowly polymerized to form a homogeneous polymer network in the liquid crystal material and thereby make the liquid crystal material have a fast-response speed when a voltage is applied thereto.

6. The liquid crystal medium mixture according to claim 5, wherein a structural formula of the antioxidant is 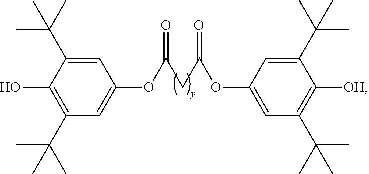
where y is in the range of 1-11.

7. The liquid crystal medium mixture according to claim 5, wherein a ratio of a mass of the antioxidant occupied in a total mass of the liquid crystal medium mixture is greater than 0 and less than or equal to 1%, and a mass of the polymerizable monomer is 0.3%-30% of the total mass of the liquid crystal medium mixture.

8. The liquid crystal medium mixture according to claim 5, wherein the polymerizable monomer comprises at least one selected from a group consisting of acrylate, acrylate derivative, methacrylate, methacrylate derivative, styrene, styrene derivative, epoxy resin and aliphatic amine epoxy resin.

9. The liquid crystal medium mixture according to claim 8, wherein a structural formula of the polymerizable monomer is 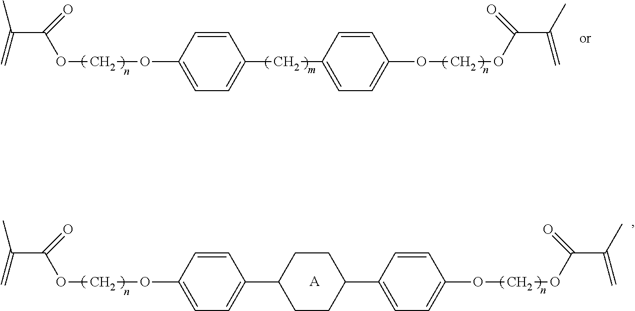
where m is in the range of 1-6, n is in the range of 1-7, and A is one selected from one of a group consisting of benzene, benzyl, fluorobenzene, para-ethyl benzene, para-propyl benzene and para-methanoic phenyl ester.

10. The liquid crystal medium mixture according to claim 5, wherein the liquid crystal material comprises a diluent, a first monomer and a second monomer; the first monomer is configured for increasing a birefringence of the liquid crystal material and the second monomer is configured for increasing a negative dielectric anisotropy of the liquid crystal material.

11. A liquid crystal display panel comprising:
oppositely disposed a first substrate and a second substrate, and a liquid crystal medium mixture disposed between the first substrate and the second substrate; wherein the liquid crystal medium mixture comprises a liquid crystal material, an antioxidant and at least one kind of polymerizable monomer capable of undergoing polymerization reaction under ultraviolet light irradiation; when under an ultraviolet light irradiation, the antioxidant is configured for making the polymerizable monomer be slowly polymerized to form a homogeneous polymer network in the liquid crystal material and thereby make the liquid crystal material have a fast-response speed when a voltage is applied thereto.

12. The liquid crystal display panel according to claim 11, wherein a structural formula of the antioxidant is 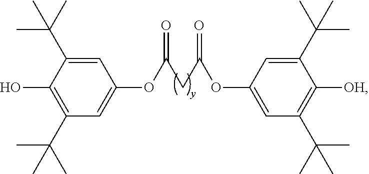
where y is in the range of 1-11.

13. The liquid crystal display panel according to claim 11, wherein a ratio of a mass of the antioxidant occupied in a total mass of the liquid crystal medium mixture is greater than 0 and less than or equal to 1%, and a mass of the polymerizable monomer is 0.3%-30% of the total mass of the liquid crystal medium mixture.

14. The liquid crystal display panel according to claim 11, wherein the polymerizable monomer comprises at least one selected from a group consisting of acrylate, acrylate derivative, methacrylate, methacrylate derivative, styrene, styrene derivative, epoxy resin and aliphatic amine epoxy resin.

15. The liquid crystal display panel according to claim 14, wherein a structural formula of the polymerizable monomer is 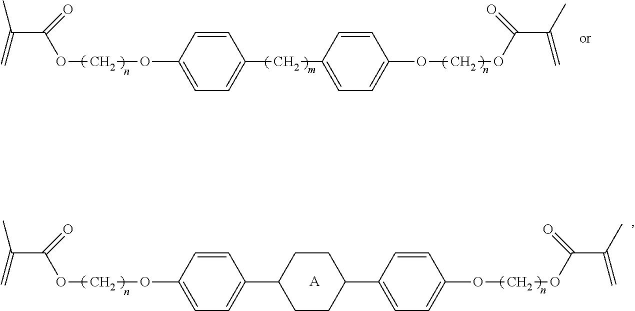
where m is in the range of 1-6, n is in the range of 1-7, and A is one selected from a group consisting of benzene, benzyl, fluorobenzene, para-ethyl benzene, para-propyl benzene and para-methanoic phenyl ester.

16. The liquid crystal display panel according to claim 11, wherein the liquid crystal material comprises a diluent, a first monomer and a second monomer; the first monomer is configured for increasing a birefringence of the liquid crystal material, and the second monomer is configured for increasing a negative dielectric anisotropy of the liquid crystal material.
